(19) United States
(12) Patent Application Publication
(10) Pub. No.: US 2011/0192564 A1
(43) Pub. Date: Aug. 11, 2011

(54) THERMALLY CONDUCTIVE FOAM MATERIAL

(75) Inventors: Cedric Mommer, Moresnet (BE); Benjamin Mardaga, Waremme (BE); Ahmet Comert, Herve (BE); Georges Moineau, Battice (BE); James Holtzinger, Clifton Park, NY (US); Joseph B. MacDonald, Hoosick Falls, NY (US); Steven R. Jette, Auburn, MA (US)

(73) Assignee: SAINT-GOBAIN PERFORMANCE PLASTICS CORPORATION, Aurora, OH (US)

(21) Appl. No.: 12/974,937

(22) Filed: Dec. 21, 2010

Related U.S. Application Data
(60) Provisional application No. 61/288,736, filed on Dec. 21, 2009.

(51) Int. Cl. F28D 17/00; B32B 3/00; B32B 7/02

(52) U.S. Cl. 165/10; 428/220; 428/212

(57) ABSTRACT

An energy supply system includes an energy storage device including a housing. The energy supply system also includes a sheet material in contact with the housing. The sheet material includes a foam layer. The sheet material has a thermal conductivity of at least 0.1 W/mK and a thickness of at least 0.3 mm.

### CROSS-REFERENCE TO RELATED APPLICATION(S)

The present application claims priority from U.S. Provisional Patent Application No. 61/288,736, filed Dec. 21, 2009, entitled “THERMALLY CONDUCTIVE FOAM MATERIAL,” naming inventors Cedric Mommer, Benjamin Mardaga, Ahmet Comert, Georges Moineau, James Holtzinger and Joe MacDonald, which application is incorporated by reference herein in its entirety.

### FIELD OF THE DISCLOSURE

This disclosure, in general, relates to thermally conductive foam materials and energy supply systems using same.

### BACKGROUND

With uncertainty about the price of oil and increasing concern about the environmental impact of hydrocarbon fuels, there is great interest in modifying energy use and in the use of alternative energy sources. Such concerns have particular impact on the automobile since the average automobile uses a considerable amount of hydrocarbon fuel derived from oil and can produce various pollutants. As such, the automobile industry is seeking to develop hybrid and electric vehicles.

Both hybrid and electric vehicles utilize electric storage, often batteries and other chemical-based electric storage systems. For example, in hybrid vehicles, a battery is discharged as the vehicle is used, but can also be charged through energy recovery during braking or by small combustion engine-driven generators. For electric vehicles, batteries discharge during use and are typically recharged by plugging them into a power source when they are no longer in use.

In each case, discharge and recharge of the electric storage units generates heat that can build temperature within the electric storage unit. Increased temperature can degrade batteries and other chemical-based storage units, reducing battery life. In addition, excess temperatures can degrade components surrounding the electrical storage units, including housings and potting materials, and in extreme cases, can even cause fire.

As such, an improved electric storage unit would be desirable.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary sheet material.

FIG. 2 includes an illustration of a cross-section of an exemplary sheet material.

FIG. 3 and FIG. 4 include illustrations of exemplary energy supply systems.

FIG. 5 includes an illustration of an exemplary energy storage system of a vehicle.

The use of the same reference symbols in different drawings indicates similar or identical items.

### DESCRIPTION OF THE PREFERRED EMBODIMENT(S)

In a particular embodiment, an energy supply system includes an energy storage device and a sheet material in contact with a housing of the energy storage device. In an example, the sheet material includes a foam layer, and the sheet material has a thermal conductivity of at least 0.1 W/mK and a thickness of at least 0.3 mm. In addition, the foam layer can have a desirable thermal stability. Further, the sheet material can include a fabric support on which the foam layer is disposed. In particular, the fabric support is disposed on the foam layer opposite the housing. In a further example, the sheet material can include a thermally conductive adhesive disposed on the foam layer, such as between the foam layer and the housing.

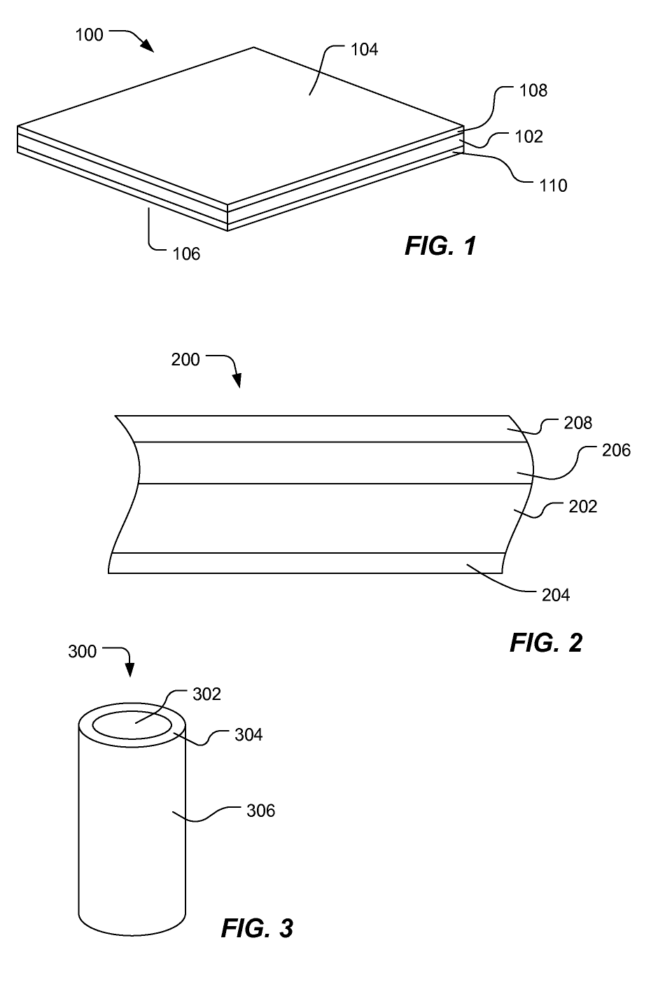

As illustrated in FIG. 1, an exemplary sheet material 100 can include a foam layer 102 having major surfaces 104 and 106. In an example, the sheet material 100 includes a major surface 104 to be placed in proximity to an energy storage device. In addition, the sheet material 100 can include a major surface 106 to be located further away from the energy storage device than the major surface 104. In an example, an adhesive layer 108, such as a thermally conductive adhesive, can be disposed on the foam layer 102 proximal to the major surface 104 of the sheet material 100. In a further example, a support layer 110 can be disposed on the foam layer 102 proximal to the major surface 106 of the sheet material 100. As such, the adhesive layer 108 is to contact the energy supply device when the sheet material 100 is deployed, and the support layer 106 is to be disposed on an opposite side of the foam layer 102 relative to the energy storage device.

As further illustrated in the exemplary cross-section illustrated by FIG. 2, a sheet material 200 can include a foam layer 202. The foam layer 202 can be disposed on a support layer 204. In addition, an adhesive layer 206 can be disposed on a surface of the foam layer 202 opposite the support layer 204. Prior to deployment, a release liner 208 can be disposed on the adhesive layer 206 opposite the foam layer 202. When deployed, the release liner 208 can be removed, exposing the adhesive layer 206 and permitting the adhesive to be placed in contact with a housing of an energy storage device.

Optionally, additional layers not illustrated can be included in the sheet material. For example, an additional adhesive layer can be disposed between the foam layer 202 and the support layer 204. In another example, an adhesive layer can be disposed on the support layer 204 on a side opposite the foam layer 202 and optionally, a liner can be disposed on the additional adhesive layer. In a further example, additional support layers can be disposed within the foam layer 202.

In a particular example, the foam layer 202 is formed of a polymeric material, such as a thermoplastic polymer or a thermoset polymer. In an example, the polymer of the foam layer 202 can be selected from the group consisting of silicone, polyurethane, polyolefin, styrenic polymer, epoxy resin, acrylic, polyisocyanurate, a diene elastomer, fluoroelastomer, or any combination thereof. In a particular example, the polymer can be a silicone polymer. In another example, the polymer can include polyurethane, polyisocyanurate, or any combination thereof. An exemplary polyolefin includes polyethylene, polypropylene, ethylene propylene copolymer, ethylene butene copolymer, ethylene octene copolymer, or any combination thereof. An exemplary styrenic polymer includes a polymer having at least one block of polystyrene, such as polystyrene, acrylonitrile butadiene styrene copolymer (ABS), styrene-butadiene (SB), styrene-butadiene-styrene (SBS), styrene-isoprene-styrene (SIS), styrene-isoprene (SI), styrene-ethylene-butylene-styrene (SEBS), styrene-ethylene-butylene (SEB), styrene-ethylene-propylene-styrene (SEPS), isoprene-isobutylene rubbers (IIR), styrene-ethylene-propylene (SEP), or any combination thereof. A diene elastomer is a cross-linkable copolymer including a diene monomer, for example, ethylene propylene diene monomer (EPDM), ABS, or any combination thereof. An exemplary fluoroelastomer can include polyvinylidene fluoride; a copolymer of hexafluoropropylene and vinylidene fluoride; a copolymer of tetrafluoroethylene, vinylidenefluoride and hexafluoropropylene (THV); a copolymer of vinylidene fluoride, hexafluoropropylene, tetrafluoroethylene, and perfluoromethylvinylether; a copolymer of propylene, tetrafluoroethylene, and vinylidene fluoride; a copolymer of vinylidene fluoride, hexafluoropropylene, tetrafluoroethylene, perfluoromethylvinylether, and ethylene; or any combination thereof.

In a particular example, the polyurethane is a product of a polyol and a diisocyante. The polyurethane can be a two-component polyurethane or a one-component polyurethane. In particular, the one-component polyurethane precursor is the reaction product of a polyol and an excess amount of isocyanate, resulting in a polyurethane precursor terminated with isocyanate groups. In the presence of water, a portion of the isocyanate groups are converted into amine groups, which will react with the remaining isoscyanate groups resulting in a chemically crosslinked polyurethane network. Carbon dioxide released during this process can help the foaming process.

In an example, the polyol can be a polyether polyol, a polyester polyol, modified or grafted derivatives thereof, or any combination thereof. A suitable polyether polyol can be produced by polyinsertion via double metal cyanide catalysis of alkylene oxides, by anionic polymerization of alkylene oxides in the presence of alkali hydroxides or alkali alcoholates as catalysts and with the addition of at least one initiator molecule containing 2 to 6, preferably 2 to 4, reactive hydrogen atoms in bonded form, or by cationic polymerization of alkylene oxides in the presence of Lewis acids, such as antimony pentachloride or boron fluoride etherate. A suitable alkylene oxide can contain 2 to 4 carbon atoms in the alkylene radical. An example includes tetrahydrofuran, 1,2-propylene oxide, 1,2- or 2,3-butylene oxide; ethylene oxide, 1,2-propylene oxide, or any combination thereof. The alkylene oxides can be used individually, in succession, or as a mixture. In particular, mixtures of 1,2-propylene oxide and ethylene oxide can be used, whereby the ethylene oxide is used in quantities of 10% to 50% as an ethylene oxide terminal block so that the resulting polyols display over 70% primary OH terminal groups. An example of an initiator molecule includes water or dihydric or trihydric alcohols, such as ethylene glycol, 1,2-propanediol and 1,3-propanediol, diethylene glycol, dipropylene glycol, ethane-1,4-diol, glycerol, trimethylol propane, or any combination thereof.

Suitable polyether polyols, such as polyoxypropylene polyoxyethylene polyols, have average functionalities of 1.5 to 4, such as 2 to 3, and number-average molecular weights of 800 g/mol to 25,000 g/mol, such as 800 g/mol to 14,000 g/mol, particularly 2,000 g/mol to 9,000 g/mol.

In another example, the polyol can include a polyester polyol. In an exemplary embodiment, a polyester polyol is derived from dibasic acids such as adipic, glutaric, fumaric, succinic or maleic acid, or anhydrides and di-functional alcohols, such as ethylene glycol, diethylene glycol, propylene glycol, di or tripropylene glycol, 1-4 butane diol, 1-6 hexane diol, or any combination thereof. For example, the polyester polyol can be formed by the condensation reaction of the glycol and the acid with the continuous removal of the water by-product. A small amount of high functional alcohol, such as glycerin, trimethanol propane, pentaerythritol, sucrose or sorbitol or polysaccarides can be used to increase branching of the polyester polyol. The esters of simple alcohol and the acid can be used via an ester interchange reaction where the simple alcohols are removed continuously like the water and replaced by one or more of the glycols above. Additionally, polyester polyols can be produced from aromatic acids, such as terephthalic acid, phthalic acid, 1,3,5-benzoic acid, their anhydrides, such as phthalic anhydride. In a particular example, the polyol can include an alkyl diol alkyl ester. For example, the alkyl diol alkyl ester can include trimethyl pentanediol isobutyrate, such as 2,2,4-trimethyl-1,3-pentanediol isobutyrate.

In a particular embodiment, the polyol can be a multifunctional polyol having at least two primary hydroxyl groups. For example, the polyol can have at least three primary hydroxyl groups. In a particular example, the polyol is a polyether polyol having an OH number in the range of 5 mg KOH/g to 70 mg KOH/g, such as a range of 10 mg KOH/g to 70 mg KOH/g, a range of 10 mg KOH/g to 50 mg KOH/g, or even 15 mg KOH/g to 40 mg KOH/g. In a further example, the polyether polyol can be grafted. For example, the polyol can be a polyether polyol grafted with styrene-acrylonitrile. In a further example, the polyol can include a blend of multifunctional, such as trifunctional polyether polyols, and polyols that are grafted, such as a polyether polyol having a grafted styrene-acrylonitrile moiety. In particular, the polyol is a polyether polyol, available under the trade name Lupranol® available from Elastogran by BASF Group.

The isocyanate can be derived from a variety of diisocyanates. An exemplary diisocyanate monomer can include toluene diisocyanate, m-phenylene diisocyanate, p-phenylene diisocyanate, xylene diisocyanate, 4,4′-diphenylmethane diisocyanate, hexamethylene diisocyanate, isophorone diisocyanate, polymethylene polyphenyl diisocyanate, 3,3′-dimethyl-4,4′-biphenylene diisocyanate, 3,3′-dimethyl-4,4′-diphenylmethane diisocyanate, 3,3′-dichloro-4,4′-biphenylene diisocyanate, or 1,5-naphthalene diisocyanate; their modified products, for instance, carbodiimide-modified products; or the like, or any combination thereof. Such diisocyanate monomers can be used alone or in admixture of at least two kinds. In a particular example, the isocyanate component can include methylene diphenyl diisocyanate (MDI), toluene diisocyanate (TDI), hexamethylene diisocyanate (HDI), isophorone diisocyanate (IPDI), or any combination thereof. In an example, the isocyanate can include methylene diphenyl diisocyanate (MDI) or toluene diisocyanate (TDI). In particular, the isocyanate includes methylene diphenyl diisocyanate (MDI) or derivatives thereof.

The diisocyanate can have an average functionality in a range of about 2.0 to 2.9, such as a functionality of between 2.0 and 2.7. Further, the diisocyanate can have an NCO content in the range of 5% to 35%, such as the range of 10% to 30%.

In a particular embodiment, the isocyanate component can be a modified methylene diphenyl diisocyanate (MDI). In a further example, a diisocyanate can include a mixture of diisocyanates, such as a mixture of modified methylene diphenyl diisocyanates. An exemplary diisocyanate is available under the tradename Lupranate®, available from Elastogran by the BASF Group.

In addition, the polyurethane precursor can include a catalyst. The catalyst can include an organometallic catalyst, an amine catalyst, or a combination thereof. An organometallic catalyst, for example, can include dibutyltin dilaurate, a lithium carboxylate, tetrabutyl titanate, a bismuth carboxylate, or any combination thereof.

The amine catalyst can include a tertiary amine, such as tributylamine, N-methyl morpholine, N-ethyl morpholine, N,N,N′,N′-tetramethyl ethylene diamine, pentamethyl diethylene triamine and higher homologues, 1,4-diazabicyclo-[2,2,2]-octane, N-methyl-N′-dimethylaminoethyl piperazine, bis(dimethylaminoalkyl)piperazine, N,N-dimethyl benzylamine, N,N-dimethyl cyclohexylamine, N,N-diethyl benzylamine, bis(N,N-diethylaminoethyl)adipate, N,N,N′,N′-tetramethyl-1,3-butane diamine, N,N-dimethyl-β-phenyl ethylamine, bis(dimethylaminopropyl)urea, bis(dimethylaminopropyl)amine, 1,2-dimethyl imidazole, 2-methyl imidazole, monocyclic and bicyclic amidine, bis(dialkylamino)alkyl ether, such as e.g., bis(dimethylaminoethyl)ethers, tertiary amines having amide groups (such as formamide groups), or any combination thereof. Another example of a catalyst component includes Mannich bases including secondary amines, such as dimethylamine, or aldehyde, such as formaldehyde, or ketone such as acetone, methyl ethyl ketone or cyclohexanone or phenol, such as phenol, nonyl phenol or bisphenol. A catalyst in the form of a tertiary amine having hydrogen atoms that are active with respect to isocyanate groups can include triethanolamine, triisopropanolamine, N-methyldiethanolamine, N-ethyl diethanolamine, N,N-dimethyl ethanolamine, reaction products thereof with alkylene oxides such as propylene oxide or ethylene oxide, or secondary-tertiary amines, or any combination thereof. Silamines with carbon-silicon bonds can also be used as catalysts, for example, 2,2,4-trimethyl-2-silamorpholine, 1,3-diethyl aminomethyl tetramethyl disiloxane, or any combination thereof.

In a further example, the amine catalyst is selected from a pentamethyl diethylene triamine, dimethylaminopropylamine, N,N′ dimethylpiperazine and dimorpholinoethylether, N,N′ dimethyl aminoethyl N-methyl piperazine, JEFFCAT®DM-70 (a mixture of N,N′ dimethylpiperazine and dimorpholinoethylether), imadozoles, triazines, or any combination thereof.

In a particular embodiment, the catalyst is particularly useful for activating blowing reactions, such as a reaction of isocyanate with water. In an example, the catalyst includes dimorpholinodiethyl ether (DMDEE). In a particular example, the catalyst includes a stabilized version of DMDEE.

An example composition includes the polyol in an amount in the range of 50 wt % to 80 wt %, such as a range of 55 wt % to 75 wt %, or even a range of 60 wt % to 70 wt %. The diisocyanate can be included in an amount in a range of 20 wt % to 35 wt %, such as a range of 22 wt % to 32 wt %, or even a range of 25 wt % to 30 wt %. The catalyst, and in particular a humidifier curing catalyst, can be included in an amount of 0.2 wt % to 2.0 wt %, such as a range of 0.6 wt % to 1.8 wt %, a range of 0.8 wt % to 1.8 wt %, or even a range of 1.0 wt % to 1.5 wt %.

In an alternative example, the foam layer 202 can include a silicone polymer. An exemplary silicone includes polysiloxane having chain substituents selected from hydride, methyl, ethyl, propyl, vinyl, phenyl, and fluorocarbon. The terminal groups of the polysiloxane can include hydride, hydroxyl, vinyl, vinyl diorganosiloxy, alkoxy, acyloxy, allyl, oxime, aminoxy, isopropenoxy, epoxy, mercapto groups, or any combination thereof, some of which can react to cross-link or cure the polysiloxane into a silicone matrix. Particular silicone polymers can include polyalkylsiloxane, phenylsilicone, fluorosilicone, or any combination thereof.

An exemplary silicone polymer can, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In another embodiment, the polyalkylsiloxane is a silicone hydride-containing polydimethylsiloxane. In a further embodiment, the polyalkylsiloxane is a vinyl-containing polydimethylsiloxane.

In yet another embodiment, the silicone polymer is a combination of a hydride-containing polydimethylsiloxane and a vinyl-containing polydimethylsiloxane. In an example, the silicone polymer is non-polar and is free of halide functional groups, such as chlorine and fluorine, and of phenyl functional groups. Alternatively, the silicone polymer can include halide functional groups or phenyl functional groups. For example, the silicone polymer can include fluorosilicone or phenylsilicone.

Silicone polymers can include MQ silicone polymers having only methyl groups on the polymer chain; VMQ silicone polymers having methyl and vinyl groups on the polymer chain; PMQ silicone polymers having methyl and phenyl groups on the polymer chain; PVMQ silicone polymers having methyl, phenyl and vinyl groups on the polymer chain; and FVMQ silicone polymers having methyl, vinyl and fluoro groups on the polymer chain. Particular embodiments of such elastomers include the SilasticB silicone elastomers from Dow Corning.

The silicone formulation can further include a catalyst and other optional additives. Exemplary additives can include, individually or in combination, fillers, inhibitors, colorants, and pigments. In an embodiment, the silicone formulation is a platinum catalyzed silicone formulation. Alternatively, the silicone formulation can be a peroxide catalyzed silicone formulation. In another example, the silicone formulation can be a combination of a platinum catalyzed and peroxide catalyzed silicone formulation. The silicone formulation can be a room temperature vulcanizable (RTV) formulation or a gel. In an example, the silicone formulation can be a liquid silicone rubber (LSR) or a high consistency gum rubber (HCR). In a particular embodiment, the silicone formulation is a platinum catalyzed LSR. In a further embodiment, the silicone formulation is an LSR formed from a two-part reactive system.

The silicone formulation can be a conventional, commercially prepared silicone polymer. The commercially prepared silicone polymer typically includes the non-polar silicone polymer, a catalyst, a filler, and optional additives. “Conventional” as used herein refers to a commercially prepared silicone polymer that is free of any self-bonding moiety or additive. Particular embodiments of conventional, commercially prepared LSR include Wacker ElastosilB LR 3003150 by Wacker Silicone of Adrian, Mich. and Rhodia SilbioneB LSR 4340 by Rhodia Silicones of Ventura, Calif. In another example, the silicone polymer is an HCR, such as Wacker ElastosilQ3 R4000150 available from Wacker Silicone, or HS-50 High Strength HCR available from Dow Corning.

In an exemplary embodiment, a conventional, commercially prepared silicone polymer is available as a two-part reactive system. Part 1 typically includes a vinyl-containing polydialkylsiloxane, a filler, and catalyst, and Part 2 typically includes a hydride-containing polydialkylsiloxane and optionally, a vinyl-containing polydialkylsiloxane and other additives. A reaction inhibitor can be included in Part 1 or Part 2. Mixing Part 1 and Part 2 by any suitable mixing method produces the silicone formulation. In an exemplary embodiment, the two-part system is mixed in a mixing device. In an example, the mixing device is a mixer in an injection molder. In another example, the mixing device is a mixer, such as a dough mixer, Ross mixer, two-roll mill, or Brabender mixer.

In addition, the foam layer can include fillers and additives. For example, the filler can include a thermally conductive filler. An exemplary thermally conductive layer includes a metal oxide, a metal nitride, a metal carbide, or any combination thereof. An exemplary metal oxide includes silica, alumina, alumina trihydrate, zinc oxide, zirconia, magnesium oxide, or any combination thereof. An exemplary metal nitride includes aluminum nitride, silicon nitride, boron nitride, or any combination thereof. An exemplary metal carbide includes silicon carbide, boron carbide, or any combination thereof. In particular, the thermally conductive filler is selected for thermal conductivity. For example, the thermal conductivity of the filler can be at least 20 W/mK, such as at least 50 W/mK or even at least 100 W/mK.

In an example, the foam includes the thermally conductive filler in an amount in a range of 10 wt % to 80 wt % based on the total weight of the foam, such as a range of 30 wt % to 80 wt %. For example, the thermally conductive filler can be included in an amount in a range of 45 wt % to 80 wt %, such as an amount in a range of 60 wt % to 70 wt %.

Further, the thermally conductive filler can have a desirable particle size, such as an average particle size (d50) not greater than 100 microns. For example, the average particle size of the thermally conductive filler can be not greater than 15 microns, such as not greater than 10 microns, not greater than 5 microns, or even not greater than 1 micron. In a further example, the average particle size can be not greater than 100 nanometers.

Further, the foam can include other additives and fillers. For example, the foam can include UV stabilizers, UV absorbers, processing aids, antioxidants, colorants, adjuvants, flame retardants, phase change components, or any combination thereof.

Flame retardants suitable for inclusion in the foam layer can be included in amounts in a range of 1.0 wt % to 40 wt % based on the total weight of the foam layer. An exemplary flame retardant can be intumescent or non-intumescent. Typically, the flame retardants are non-halogen containing and antimony-free. Examples of suitable flame retardants include those based on organophosphorous compounds or red phosphorus materials non-halogenated fire retardants. Examples of suitable flame retardants that also function as thermally conductive fillers include aluminum hydroxide and magnesium hydroxide. In addition, blends of flame retardants can be used.

The cells of the foam can be formed as a result of frothing prior to curing or solidifying, as a result of a foaming agent, or any combination thereof. Useful foaming agents include entrained gases/high pressure injectable gases; blowing agents, such as chemical blowing agents and physical blowing agents; expanded or unexpanded polymeric bubbles; and combinations thereof. For example, cells of the foam can be formed as a result of frothing using an inert gas, such as nitrogen, carbon dioxide, air, another gas, or any combination thereof. In another example, the cells of the foam can be formed as a result of a physical blowing agent, such as hydrocarbons, ethers, esters and partially halogenated hydrocarbons, ethers and esters, and the like, or any combination thereof. An exemplary physical blowing agent includes HCFCs (halo chlorofluorocarbons) such as 1,1-dichloro-1-fluoroethane, 1,1-dichloro-2,2,2-trifluoro-ethane, monochlorodifluoromethane, or 1-chloro-1,1-difluoroethane; HFCs (halo fluorocarbons), such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, or pentafluoroethane; HFE (halo fluoroethers), such as methyl-1,1,1-trifluoroethylether and difluoromethyl-1,1,1-trifluoroethylether; and hydrocarbon, such as n-pentane, butane, isopentane, or cyclopentane; or any combination thereof.

Exemplary of chemical blowing agents include water and ado-, carbonate-, and hydrazide-based molecules including, for example, 4,4′-oxybis(benzenesulfonyl)hydrazide, such as CELOGEN OT (available from Uniroyal Chemical Company, Inc., Middlebury, Conn.), 4,4′ oxybenzenesulfonyl semicarbazide, p-toluenesulfonyl semicarbazide, p-toluenesulfonyl I hydrazide, oxalic acid hydrazide, diphenyloxide-4,4′-disulphohydrazide, benzenesulfonhydrazide, azodicarbonamide, azodicarbonamide(1,1′-azobisformamide), meta-modified azodicarbonides, 5-phenyltetrazole, 5-phenyltetrazole analogues, hydrazocarboxylates, diisopropyl lydrazodicarboxylate, barium azodicarboxylate, 5 phenyl-3,6-dihydro-1,3,4-oxadiazin-2-one, sodium borohydride, azodiisobutyronitrile, trihydrazinotriazine, metal salts of azodicarboxylic acids, tetrazole compounds, sodium bicarbonate, ammonium bicarbonate, preparations of carbonate compounds and polycarbonic acids, mixtures of citric acid and sodium bicarbonate, N,N′-dimethyl N,N′-dinitroso-terephthalamide,N,N′-dinitrosopentamethylenetetramine, or any combination thereof. Silicone carbide can function as a chemical blowing agent and a thermally conductive filler. In the case of polyurethane foam or a polyisocyanurate, the cells of the foam can be formed with the addition of water and excess diisocyanate to the reactive mixture resulting in the release of carbon dioxide.

Following formation, the foam of the foam layer 202 can be a closed cell foam or can be an open cell foam. In particular, the foam can be a closed cell foam. Further, the foam can have a density not greater than 1500 kg/m³, such as a density of not greater than 1200 kg/m³, not greater than 1000 kg/m³, or even a density of not greater than 800 kg/m³. In an example, the density is at least 20 kg/m³, such as at least 100 kg/m³, or even at least 200 kg/m³.

In addition to desirable low density, the foam of the foam layer 202 can have a desirable flexibility. For example, the foam can have a desirable compression deflection at 25% compression of not greater than 50 psi (345 kPa) as determined in accordance with ASTM D1056. For example, the compression deflection at 25% can be not greater than 30 psi (207 kPa), such as not greater than 25 psi (172 kPa). Further, the compression deflection at 25% compression can be at least 0.7 psi (5 kPa), such as at least 2 psi (13.8 kPa), or even at least 5 psi (34.5 kPa). In addition, the foam can have a desirable hardness, such as a desirable Shore A hardness of not greater than 40. For example, the Shore A hardness of the foam can be not greater than 30, such as not greater than 20, or even not greater than 15.

In an additional example, the sheet material includes a support layer 204. An exemplary support layer 204 includes a polymeric film, such as polyolefin film (e.g., polypropylene including biaxially oriented polypropylene), polyester film (e.g., polyethylene terephthalate), polyamide film, unfoamed silicone film, unfoamed polyurethane film, perflourinated polymer film (e.g., PTFE), or cellulose ester film; mesh; cloth (e.g., cloth made from fibers or yams comprising polyester, nylon, silk, cotton, poly-cotton or rayon); paper; vulcanized paper; vulcanized rubber; vulcanized fiber; nonwoven materials; a combination thereof; or a treated version thereof. An exemplary cloth can be woven or stitch bonded. In particular examples, the support layer 204 is selected from the group consisting of paper, polymer film, cloth, cotton, poly-cotton, rayon, polyester, poly-nylon, vulcanized rubber, vulcanized fiber, and a combination thereof. In other examples, the support includes polypropylene film or polyethylene terephthalate (PET) film. In particular, the support layer 204 can include a fibrous material, such as a woven fabric or cloth or a random fiber fabric or cloth. In an example, the fabric includes fiberglass, such as a woven fiberglass fabric. In another example, the fabric is formed of fibers of polyester, aramid, polyimide, carbon fiber, or any combination thereof. While a single support layer 204 is illustrated in FIG. 2, additional support layers can be included.

In an additional example, the sheet material 200 can include an adhesive layer 206, which can include a thermally conductive adhesive. For example, the adhesive can be a pressure sensitive adhesive. In another example, the adhesive is a hot melted adhesive. In addition, the adhesive can include thermally conductive filler or a phase change component, such as those fillers and components described above. Further, the adhesive can have a desirable thermal conductivity, such as a thermal conductivity of at least 0.3 W/mK, such as at least 0.4 W/mK, at least 0.5 W/mK, or even at least 1.0 W/mK.

In particular, the sheet material 200 exhibits a desirable thermal conductivity determined in accordance with ASTM E1530. For example, the sheet material 200 can have a thermal conductivity of at least 0.1 W/mK, such as a thermal conductivity of at least 0.25 W/mK, at least 0.3 W/mK, at least 0.4 W/mK, or even at least 0.5 W/mK. In a particular example, the sheet material 200 can have a thermal conductivity of at least 5 W/mK, such as at least 10 W/mK, or even at least 15 W/mK. In an example, the thermal conductivity of the sheet material 200 increases when the sheet material 200 is used under compression. For example, the sheet material 200 can be wrapped tightly, causing a compression of particular layers, such as the foam layer 202, when in use. In particular, the sheet material 200 can have a compressed thermal conductivity, defined as the thermal conductivity of the sheet material 200 at 50% compression, of at least 0.55 W/mK. For example, the compressed thermal conductivity can be at least 0.6 W/mK, such as at least 0.65 W/mK. In particular, the sheet material can have a compressed thermal conductivity of at least 5 W/mK, such as at least 10 W/mK, or even at least 15 W/mK.

Further, the sheet material 200 can have a desirable thickness, such as a thickness of at least 0.3 mm. In an example, the thickness is not greater than 25 mm. For example, the thickness can be in a range of 0.5 mm to 10 mm, such as a range of 0.5 mm to 5 mm, or even a range of 0.5 mm to 1 mm.

In addition, the sheet material 200 has a desirable dielectric strength as measured in accordance with ASTM D149. For example, the sheet material can have a dielectric strength of at least 50 V/mil, such as at least 75 V/mil, or even at least 100 V/mil.

Further, the sheet material 200 is stable at high temperatures. For example, thermal stability is correlated with compression set at elevated temperatures in accordance with ASTM D1056. In particular, the sheet material 200 exhibits a compression set of not greater than 20% at 100° C. over a period of two weeks. In an example, the compression set of the sheet material 200 can be not greater than 15%, such as not greater than 10%. In addition, the sheet material 200 can be flame retardant, such as having a rating of V1.

In another example, the sheet material 200 has desirable mechanical strength and integrity. For example, the sheet material 200 can have a tensile strength (break strength) determined in accordance with ASTM D412 of at least 90 psi (0.62 MPa), such as at least 100 psi (0.69 MPa), at least 110 psi (0.76 MPa), or even at least 120 psi (0.82 MPa). Further, the sheet material 200 can have a tensile strength of at least 200 psi (1.4 MPa), such as at least 500 psi (3.4 MPa), at least 1000 psi (6.9 MPa), at least 1200 psi (8.3 MPa), or even at least 1400 psi (9.6 MPa).

The above described sheet material is particularly useful for surrounding batteries and other chemical-based electricity storage units. In a typical automotive application, a plurality of batteries is encased in an electrical system. The above described sheet material is particularly useful for surrounding each battery individually within the electrical system. In particular, the sheet material has a desirable thermal conductivity and a desirable thermal stability, providing the sheet material with durability when faced with higher temperatures during battery discharge. Further, the foam can flex to maintain the sheet material in contact with the housing of the batteries, providing improved contact for heat transfer. In addition, the sheet material can be wrapped tightly around individual batteries while permitting a degree of thermal expansion that can result from increased temperature of the electric storage unit during discharge or recharge.

In a particular example, a sheet material has a combination of a high thermal conductivity despite the thickness, thermal stability, and durability or strength. Such a combination provides advantages over melt pressure sensitive adhesive materials, particularly traditional thermal interface materials. In addition, such a sheet material has weight and handling advantages relative to thermally conductive potting materials.

In a particular example, FIG. 3 includes an illustration of an exemplary battery 300. Battery 300 has a cylindrical configuration in which an energy storage device 302 is surrounded with the sheet material 304 around its circumferential surface 306. In such an example, the foam or optionally, an adhesive layer of the sheet material can be in contact with the housing of the energy storage device 302. The support layer of the sheet material 304 can form an outer surface of the sheet material 304 around the circumferential surface 306 of the energy storage device 302.

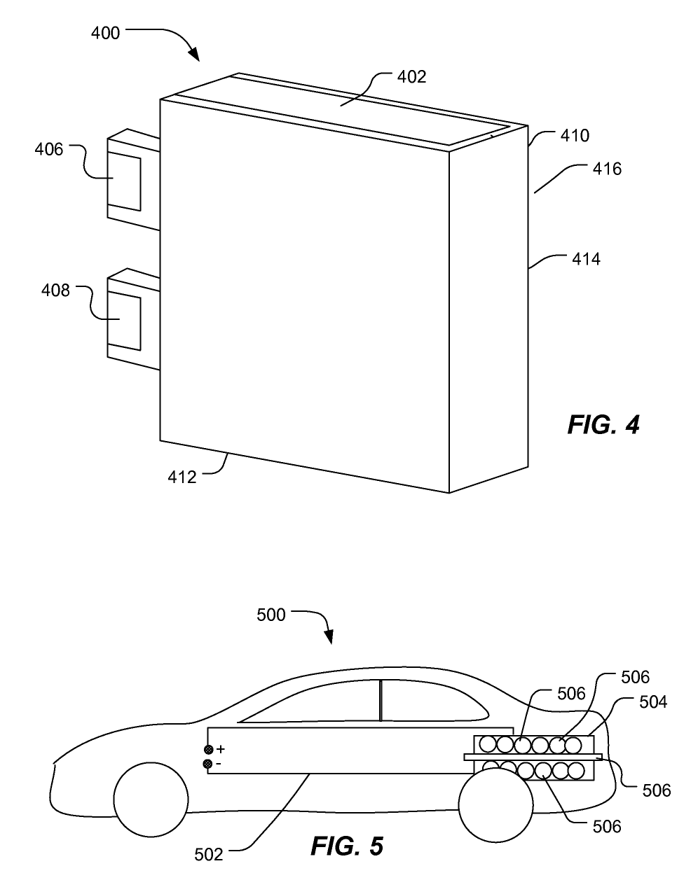

In another example illustrated in FIG. 4, an energy supply component 400 has a box-shaped energy supply device 402 having electrical contacts 406 and 408. An exemplary sheet material 410 can surround major surfaces 412, 414 and 416 of the energy storage device 402 without hindering the contacts 406 and 408. In an example, the foam layer or optionally, an adhesive layer of the sheet material 410 can be in contact with the housing of the energy storage device 402. Further, a reinforcing layer can form an outer surface of the sheet material 410 on a side of a foam layer opposite the housing of the energy storage device 402.

In a particular example, a plurality of the individually wrapped energy storage devices can be incorporated into an electrical system of a vehicle. For example, as illustrated in FIG. 5, a vehicle 500 includes an electrical system 502. The electrical system 502 includes an energy supply section 504 including a plurality of energy storage devices 506. A thermally conductive sheet material can extend between rows of the energy storage devices 506. In another example, a thermally conductive sheet material can interweave between energy storage devices 506. In a further example, the energy storage devices 506 can be individually wrapped with the thermally conductive sheet material. In addition, the energy supply section 504 can include conduits 508 for supplying a temperature control medium. For example, when the energy supply section 504 is in use, the temperature control medium can cool the energy supply section 504 and the individually wrapped energy storage devices 506. When the temperature of the energy supply section 504 drops as a result of inclement weather, the temperature control medium can heat the energy storage devices 506. As such, thermal energy can be transferred into or out of the energy storage devices through their individual wrappings of sheet material.

Depending on the nature of the foam, the foam can be cured, such as through thermal curing or can be cured using actinic radiation, such as UV curing. Further, the curing can be catalyzed. For example, a silicone foam can be cured through the use of a peroxide or platinum catalyst. Alternatively, when a thermoplastic is used for the foam material, the foam can be solidified by cooling.

As illustrated, additional layers can be incorporated into the sheet material. For example, reinforcement layers can be incorporated into the foam layer, such as by partially applying the foam layer over the support layer, followed by application of the reinforcement layer over the foam layer and subsequent dispensing additional foaming material over the reinforcement layer.

In a first aspect of the invention, a sheet material includes a support layer and a foam layer disposed on the support layer. The sheet material has a thickness in a range of 0.3 mm to 25 mm and a thermal conductivity of at least 0.1 W/mK. In an example of the first aspect, the foam layer has a compression set at 100° C. over a period of two weeks of not greater than 15%.

In an embodiment of the first aspect, the sheet material has a thermal conductivity of at least 0.25 W/mK, such as at least 0.3 W/mK, at least 0.55 W/mK, at least 0.6 W/mK, or even at least 0.65 W/mK.

In an additional embodiment of the first aspect, the thickness is not greater than 25 mm. For example, the thickness is in the range of 0.5 mm to 10 mm, such as the range of 0.5 mm to 5 mm or even the range of 0.5 mm to 1 mm.

In another embodiment of the first aspect, the support layer comprises fiberglass fabric, an unfoamed silicone film, an unfoamed polyurethane film, or a perfluoropolymer film.

In a further embodiment of the first aspect, the sheet material further includes an adhesive layer disposed on the foam layer on a side opposite the support layer. The adhesive has a thermal conductivity of at least 0.3 W/mK.

In an additional embodiment of the first aspect, the foam layer includes a polymer selected from the group consisting of silicone, polyurethane, polyolefin, styrenic polymer, epoxy resin, polyisocyanurate, or any combination thereof. For example, the polymer comprises silicone. In another example, the polymer comprises polyurethane, polyisocyanurate, or any combination thereof.

In another embodiment of the first aspect, the foam layer comprises thermally conductive filler. The thermally conductive filler can be selected from the group consisting of metal oxide, metal nitride, metal carbide, or any combination thereof. In an example, the metal oxide is silica, alumina, alumina trihydrate, zinc oxide, zirconia, magnesium oxide, or any combination thereof. In a further example, the metal nitride is aluminum nitride, silicon nitride, boron nitride, or any combination thereof. In an additional example, the metal carbide is silicon carbide, boron carbide, or any combination thereof. The thermally conductive filler has a thermal conductivity of at least 20 W/mK, such as at least 50 W/mK, or even at least 100 W/mK. The foam layer can include the thermally conductive filler in an amount of 10 wt % to 80 wt % based on the total weight of the foam layer, such as a range of 45 wt % to 80 wt %, or even a range of 60 wt % to 70 wt %. The thermally conductive filler can have an average particle size not greater than 100 microns, such as not greater than 15 microns, not greater than 10 microns, not greater than 5 micrometer, not greater than 1 micrometer, or even not greater than 100 nm.

In a further embodiment of the first aspect, the foam layer has a compression deflection at 25% of not greater than 50 psi, such as not greater than 30 psi, or even not greater than 25 psi. The foam layer can have a density of not greater than 1500 kg/m³, such as not greater than 1200 kg/m³, or even not greater than 1000 kg/m³.

In an additional embodiment of the first aspects, the sheet material has a dielectric strength of at least 50 V/mil.

In a second aspect of the invention, a sheet material includes a fabric support, a foam layer disposed on the fabric support, and an adhesive disposed on the foam layer opposite the fabric support. The sheet material has a thermal conductivity of at least 0.1 W/mK, a thickness in a range of 0.3 mm to 25 mm, and a compression set of not greater than 15% at 100° C. over a period of two weeks.

In a third aspect of the invention, an energy supply system includes an energy storage device including a housing and a sheet material in contact with the housing. The sheet material includes a foam layer. The sheet material has a thermal conductivity of at least 0.1 W/mK and a thickness of at least 0.3 mm.

In an embodiment of the third aspect, the foam has a compression set at 100° C. over a period of two weeks of not greater than 15%.

In an additional embodiment of the third aspect, the sheet material has a thermal conductivity of at least 0.25 W/mK, such as at least 0.3 W/mK or at least 0.55 W/mK.

In a further embodiment of the third aspect, the thickness is not greater than 25 mm, such as the range of 0.5 mm to 10 mm.

In another embodiment of the third aspect, the sheet material further comprises a support layer. The support layer can be disposed on a major surface of the foam opposite the housing. In an example, the support layer can be fiberglass fabric. In another example, the support layer includes an unfoamed silicone film. In an additional example, the support layer includes an unfoamed polyurethane film. In a further example, the support layer includes a perfluoropolymer film.

In an additional embodiment of the third aspect, the sheet material includes an adhesive layer. The adhesive can have a thermal conductivity of at least 0.3 W/mK. The adhesive can be disposed between the foam layer and the housing.

In a further embodiment of the third aspect, the foam layer includes a polymer selected from the group consisting of silicone, polyurethane, polyolefin, styrenic polymer, epoxy resin, polyisocyanurate, or any combination thereof. In an example, the polymer includes silicone. In another example, the polymer includes polyurethane, polyisocyanurate, or any combination thereof.

In another embodiment of the third aspect, the foam layer includes thermally conductive filler. The thermally conductive filler can be selected from the group consisting of metal oxide, metal nitride, metal carbide, or any combination thereof. In an example, the metal oxide is silica, alumina, alumina trihydrate, zinc oxide, zirconia, magnesium oxide, or any combination thereof. In another example, the metal nitride is aluminum nitride, silicon nitride, boron nitride, or any combination thereof. In an additional example, the metal carbide is silicon carbide, boron carbide, or any combination thereof. The thermally conductive filler can have a thermal conductivity of at least 20 W/mK. The foam layer can include the thermally conductive filler in an amount of 10 wt % to 80 wt % based on the total weight of the foam layer. The thermally conductive filler can have an average particle size not greater than 100 microns, such as not greater than 15 microns.

In an additional embodiment of the third aspect, the foam layer has a compression deflection at 25% of not greater than 50 psi. In another embodiment, the sheet material has a dielectric strength of at least 50 V/mil.

In a further embodiment of the third aspect, the foam layer has a density of not greater than 1500 kg/m³, such as not greater than 1200 kg/m³ or even not greater than 1000 kg/m³.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A sheet material comprising:
a support layer; and
a foam layer disposed on the support layer;
wherein the sheet material has a thickness in a range of 0.3 mm to 25 mm and a thermal conductivity of at least 0.1 W/mK.

2. The sheet material of claim 1, wherein the foam layer has a compression set at 100° C. over a period of two weeks of not greater than 15%.

3. The sheet material of claim 1, wherein the sheet material has a thermal conductivity of at least 0.25 W/mK.

4. The sheet material of claim 1, wherein the sheet material has a compressed thermal conductivity of at least 0.3 W/mK.

5.-7. (canceled)

8. The sheet material of claim 1, wherein the thickness is not greater than 25 mm.

9.-11. (canceled)

12. The sheet material of claim 1, wherein the support layer comprises fiberglass fabric.

13. The sheet material of claim 1, wherein the support layer comprises an unfoamed silicone film.

14. (canceled)

15. (canceled)

16. The sheet material of claim 1, further comprising an adhesive layer disposed on the foam layer on a side opposite the support layer.

17. (canceled)

18. The sheet material of claim 1, wherein the foam layer comprises a polymer selected from the group consisting of silicone, polyurethane, polyolefin, styrenic polymer, epoxy resin, polyisocyanurate, fluoroelastomer, or any combination thereof.

19. (canceled)

20. (canceled)

21. The sheet material of claim 1, wherein the foam layer comprises thermally conductive filler.

22.-25. (canceled)

26. The sheet material of claim Error! Reference source not found, wherein the thermally conductive filler has a thermal conductivity of at least 20 W/mK.

27. (canceled)

28. (canceled)

29. The sheet material of claim Error! Reference source not found, wherein the foam layer includes the thermally conductive filler in an amount of 10 wt % to 80 wt % based on the total weight of the foam layer.

30. (canceled)

31. (canceled)

32. The sheet material of claim Error! Reference source not found, wherein the thermally conductive filler has an average particle size not greater than 100 microns.

33.-37. (canceled)

38. The sheet material of claim 1, wherein the foam layer has a compression deflection at 25% of not greater than 50 psi.

39. (canceled)

40. (canceled)

41. The sheet material of claim 1, wherein the sheet material has a dielectric strength of at least 50 V/mil.

42. The sheet material of claim 1, wherein the foam layer has a density of not greater than 1500 kg/m³.

43. (canceled)

44. (canceled)

45. A sheet material comprising:
a fabric support;
a foam layer disposed on the fabric support; and
an adhesive disposed on the foam layer opposite the fabric support;
wherein the sheet material has a thermal conductivity of at least 0.1 W/mK, a thickness in a range of 0.3 mm to 25 mm, and a compression set of not greater than 15% at 100° C. over a period of two weeks.

46. An energy supply system comprising:
an energy storage device including a housing; and
a sheet material in contact with the housing, the sheet material including a foam layer, the sheet material having a thermal conductivity of at least 0.1 W/mK and a thickness of at least 0.3 mm.

47.-52. (canceled)

53. The energy supply system of claim 46, wherein the sheet material further comprises a support layer.

54.-56. (canceled)

57. The energy supply system of claim 53, wherein the support layer comprises an unfoamed polyurethane film.

58.-78. (canceled)
